(19) United States
(12) Patent Application Publication
(10) Pub. No.: US 2021/0272705 A1
(43) Pub. Date: Sep. 2, 2021

(54) Simple and Robust Configuration for ICF Targets Using Varied Hohlraum Configurations

(71) Applicants: Robert O. Hunter, JR., Aspen, CO (US); Conner D. Galloway, Foster City, CA (US); Alexander V. Valys, Foster City, CA (US); Eric W. Cornell, Colorado Springs, CO (US)

(72) Inventors: Robert O. Hunter, JR., Aspen, CO (US); Conner D. Galloway, Foster City, CA (US); Alexander V. Valys, Foster City, CA (US); Eric W. Cornell, Colorado Springs, CO (US)

(73) Assignee: Innoven Energy LLC, Colorado Springs, CO (US)

(21) Appl. No.: 16/800,203

(22) Filed: Feb. 25, 2020

Related U.S. Application Data
(60) Provisional application No. 62/810,046, filed on Feb. 25, 2019.

(51) Int. Cl. G21B 1/03

(52) U.S. Cl. CPC G21B 1/03

(57) ABSTRACT

Various configurations for ICF targets and techniques for their utilization are disclosed which may be simpler and more robust than conventional targets. In some embodiments, these targets may operate at a large areal density (ρr), and/or may be imploded primarily by a single strong shock. In some embodiments, the entire volume of a region of fuel may be heated to a desired temperature at once, such that all the fuel mass may participate in the physical processes that may lead to fusion ignition. Targets of this type may be less sensitive to drive non-uniformity and to the temporal profile of driver energy delivery than conventional ICF targets.

### CROSS-REFERENCE TO RELATED APPLICATIONS

This application claims the benefit of U.S. Provisional Application No. 62/810,046 filed on Feb. 25, 2019, which is incorporated herein by reference.

### BACKGROUND

Nuclear fusion by inertial confinement (Inertial Confinement Fusion, or “ICF”) utilizes nuclear fusion reactions to produce energy. In most types of ICF system, an external drive mechanism such as a laser delivers energy to a target containing nuclear fusion fuel. The target is designed to use this energy to compress, heat and ignite the fusion fuel within it. If a sufficient amount of fuel is compressed sufficiently and heated sufficiently, a self-sustaining fusion reaction can occur, in which energy produced by fusion reactions continues to heat the fuel (“ignition”). The inertia of the compressed fuel can keep it from expanding long enough for significant energy to be produced, before expansion of the fuel and the resultant cooling terminates the fusion reaction. Most conventional ICF target designs involve a spherical target which is imploded symmetrically from all directions, relying on stagnation of inwardly-accelerated fuel at the center of the sphere to produce the required densities and temperatures.

Production of the very high temperatures and densities required for fusion ignition may require a substantial amount of energy. The exact amount of energy required depends on the specific target design in use. In order to be useful for energy generation, the target must be capable of producing more energy from fusion reactions than was required to ignite it. In addition, the amount of energy required by the target must be physically and/or economically realizable by the drive mechanism being used.

For this reason, conventional ICF target designs have focused on achieving the required temperatures and densities as efficiently as possible. These designs are often complex in their construction and operation, and sensitive to imperfection in the target's manufacturing and to non-uniformity in the delivery of energy to the target from the drive mechanism. Imperfection and non-uniformity can lead to asymmetry in the target's implosion, which may reduce the densities and temperatures achieved, potentially below the threshold required for ignition. Furthermore, successful operation of these complex designs often requires achieving a precise balance between multiple competing physical processes, many of which are poorly understood and difficult to model. When actually constructed and deployed, these complex ICF target designs often fail to perform as their designers intended, and to date none have actually succeeded in producing ignition.

The NIF target exemplifies the conventional approach. The NIF target, as described in Haan, Physics of Plasmas 18, 051001 (2011), involves an outer ablator shell comprising primarily plastic or beryllium with various dopants, surrounding a shell of cryogenic DT ice, with a central void filled with low-density DT gas. The target is then placed in a cylindrical hohlraum. The entire target assembly (hohlraum and target) is then placed in the target chamber where a laser consisting of 192 separate beamlines, with a total energy delivered to the hohlraum of up to 1.8 MJ, illuminates a number of spots on the inner surface of the hohlraum, producing a radiation field which fills the hohlraum. The radiation field ablates the ablator layer, and the reactive force of the ablator ablating implodes the target. The laser pulse is 18 nanoseconds long and is temporally tailored in order to drive a series of precisely-adjusted shocks into the target. The timing and energy level of these shocks are adjusted in order to achieve a quasi-isentropic, efficient implosion and compression of the shell of DT fuel. Stagnation of these shocks and inward-moving material at the center of the target is intended to result in the formation of a small “hotspot” of fuel, at a temperature of roughly 10 keV and a ρr of approximately 0.3 g/cm², surrounded by a much larger mass of relatively cold DT fuel, and it is intended that the fuel in the “hotspot” will ignite, with fusion burn then propagating into the cold outer shell.

In practice, the NIF target has so far failed to ignite, achieving peak temperatures and densities of about 3 keV and a ρr of approximately 0.1 g/cm² in the hotspot, short of the 10 keV and 0.3 g/cm² anticipated to be required for ignition. There is no clear consensus on what has caused the failure of the NIF target to achieve ignition, but it appears that this failure may be partially due to low-order asymmetry in the hotspot formation and lower than expected implosion velocities.

An ICF target design and implosion mechanism which is more robust against non-uniformities, simpler to analyze and simpler to utilize would be advantageous in achieving practical energy generation through ICF.

### SUMMARY

Various configurations for ICF targets and techniques for their utilization are disclosed which may be simpler and more robust than conventional targets. In some embodiments, these targets may operate at large ρr, and/or may be imploded primarily by a single strong shock. In some embodiments, the entire volume of a region of fuel may be heated to a desired temperature at once, such that all the fuel mass may participate in the physical processes that may lead to fusion ignition. Targets of this type may be less sensitive to drive non-uniformity and to the temporal profile of driver energy delivery than conventional ICF targets. In some embodiments, the computational requirements for design and analysis of these targets' operation may be substantially reduced compared to conventional targets.

### DRAWINGS

FIG. 1 shows a cross-section of a single shell configuration of an ICF target in a spherical hohlraum.

FIG. 2 shows a cross-section of a double shell configuration with a propellant region of an ICF target.

FIG. 3 shows a cross-section of a double shell configuration of an ICF target in a spherical hohlraum.

### DETAILED DESCRIPTION

Nuclear fusion may refer to a type of reaction that occurs when certain atomic nuclei collide. In most of these reactions, two light nuclei combine, producing heavier nuclei and/or nuclear particles. In the process, some of the energy in the nuclear bonds holding the nuclei together is released, usually settling in the form of thermal energy (heat) in the material surrounding the reacting particles. These reactions only occur between atomic nuclei that are very energetic, such as those that have been heated to a high temperature to form a plasma. The specific temperatures vary between reactions. The reaction between deuterium and tritium, two hydrogen isotopes, is generally considered to require the lowest temperature for ignition. As other fusion reactions require higher temperatures, most nuclear fusion power concepts envision the use of D-T fuel.

Two challenges in using nuclear fusion to produce power are referred to as ignition and confinement. Achieving ignition requires heating a plasma of fusion fuel until it becomes hot enough to heat itself, meaning the energy released from fusion reactions exceeds the energy lost through various processes, such as Bremsstrahlung radiation and hydrodynamic expansion. The temperature at which this occurs is known as the “ignition temperature,” which for D-T fuel can range from 2-10 keV, depending on the physical properties of the plasma. After ignition, self-heating in the fuel can cause it to reach temperatures of 100 keV or more.

Once fuel has been ignited, confinement may refer to the challenge of keeping the fuel from expanding (thus cooling and ceasing to burn) long enough for it to produce the desired amount of energy: at least as much energy as was required to ignite the fuel and keep it confined—and hopefully significantly more. While heating the fuel to ignition is simply a matter of delivering energy to it, confinement is more challenging. There is no known way to confine a plasma heated to ignition temperature or beyond with a simple mechanical system. Any solid substance, such as the metal wall of a container, that comes into contact with a fusion plasma would either become instantly vaporized, would drastically cool the plasma and stop the burn itself, or both.

The method of confinement uses a magnetic field to keep the fuel from expanding. This is referred to as Magnetic Confinement Fusion (MCF). Magnetic confinement has many inherent difficulties and disadvantages, and economical power generation from an MCF facility appears decades away.

Another approach takes advantage of how the characteristics of fusion burn change with fuel amount and density. At ordinary densities and practicable amounts, a D-T plasma heated to ignition temperature will disassemble (expand and stop burning) before producing anywhere near the energy required to originally heat it. However, as the density of a given amount of fuel is increased, the rate at which the fuel will burn increases faster than the rate at which it will expand. This means that, if the fuel can be compressed sufficiently before heating it the fuel's own resistance to notion (inertia) will keep it from expanding long enough to yield a significant amount of energy. This approach is referred to as Inertial Confinement Fusion (ICF).

Inertial Confinement Fusion reactor chambers can be designed to contain an ICF target being imploded and capture the resulting energy output from the reaction in the forms of neutrons, radiation, and/or debris. Such chambers can generally include a combination of neutron moderating layers, neutron absorbing layers, neutron shielding layers, radiation capturing layers, sacrificial layers, shock absorbers, tritium breeding layers, tritium breeders, coolant systems, injection nozzles, inert gas injection nozzles, sputterers, sacrificial coating injection nozzles, beam channels, target supporting mechanism, and/or purge ports, among others. Generally speaking, neutron moderating material can be constructed from graphite and may be naturally or artificially doped, combined, allowed, and/or mixed with neutron absorbing material and/or have a thickness of one or more neutron mean free path lengths (e.g., 0.3-1.0 m). Neutron absorbing material may include boron, cadmium, lithium, etc. Radiation tiles or layers can be disposed throughout the chamber to absorb radiation from the reaction.

The term “isentropic drive mechanism” may refer to a drive mechanism that is designed or utilized to compress material (such as fusion fuel) in an isentropic manner. “Isentropic” means compressing material while minimizing the total entropy increase (heating) of the material. Isentropic compression is therefore the most efficient way to compress material. When imploding a sphere or shell of material, such as an ICF target, isentropic compression requires that the drive mechanism deliver pressure to the material in a specific way over the entire duration of the compression, utilizing a low pressure initially that is increased over the course of the compression according to a mathematical formula. This can be difficult to achieve, and complicates the design of both the target drive mechanism and the driver that delivers energy to the drive mechanism (such as a laser or heavy ion beam).

The term “quasi-isentropic drive mechanism” may refer to a drive mechanism that approximates an ideal, perfectly-isentropic compression using a means other than a ramped pressure profile. For instance, drive mechanisms that compress material by producing a series of shocks of increasing strength may approach the efficiency a a perfectly-isentropic compression. While in some circumstances that are simpler than perfectly isentropic versions, these drive mechanisms are still complex to engineer.

The term “impulsive drive mechanism” may refer to a drive mechanism that compresses material impulsively, typically by the production of a single shock wave that accelerates the material and causes it to move inward. The pressure produced by an impulsive drive mechanism is typically highest at the beginning of the implosion, and decreases afterward. Impulsive drive mechanisms are limited in the amount of compression they can produce and in the efficiency of compression achieved. They may be simpler to design and use than other drive mechanisms. For instance, an impulsive drive mechanism may not require that the driver (laser, heavy ion beam, etc.) be active during the entire course of the implosion; but may instead deliver its energy over a shorter timescale, potentially short comparable to the timescale of hydrodynamic motion in the target.

The term “shock” may refer to sharp discontinuities in the flow of material. These discontinuities can be induced in any hydrodynamic variables such as temperature, pressure, density, velocity, etc.

The term “shock convergence” may refer to the convergence of a shock which may travel from an outer shell and to an inner shell. It is calculated as the ratio of the outer radius of an inner shell, R_{c}, and the inner radius of an outer shell Rₒ. That is,

$$SC = \frac{{R}_{O}}{{R}_{C}}$$

For instance, given a first shell with an inner radius of 10 cm, and a second shell disposed within the first shell with a inner radius of 0.5 cm, the shock convergence is 20. Any other combination of inner and outer radiuses can be used.

The term “atom” may refer to a particle of matter, composed of a nucleus of tightly-bound protons and neutrons with an electron shell. Each element has a specific number of protons.

The term “neutron” may refer to a subatomic particle with no electrical charge. Their lack of a charge means that free neutrons generally have a greater free range in matter than other particles.

The term “proton” may refer to a subatomic particle with a positive electrical charge.

The term “electron” may refer to a subatomic particle with a negative electrical charge, exactly opposite to that of a proton and having less mass than a proton and a neutron. Atoms under ordinary conditions have the same number of electrons as protons, so that their charges cancel.

The term “isotope” may refer to atoms of the same element that have the same number of protons, but a different number of neutrons. Isotopes of an element are generally identical chemically, but may have different probabilities of undergoing nuclear reactions. The term “ion” may refer to a charged particle, such as a proton or a free nucleus.

The term “plasma” may refer to the so-called fourth state of matter, beyond solid, liquid, and gas. Matter is typically in a plasma state when the material has been heated enough to separate electrons from their atomic nuclei.

The term “Bremsstrahlung radiation” may refer to radiation produced by interactions between electrons and ions in a plasma. One of the many processes that can cool a plasma is energy loss due to Bremsstrahlung radiation.

The product “ρr” may refer to the areal mass density of a material. This term may refer to a parameter that can be used to characterize fusion burn. This product is expressed in grams per centimeter squared, unless otherwise specified.

The term “runaway burn” may refer to a fusion reaction that heats itself and reaches a very high temperature. Because the D-T reaction rate increases with temperature, peaking at 67 keV, a D-T plasma heated to ignition temperature may rapidly self-heat and reach extremely high temperatures, approximately 100 keV, or higher.

The term “burn fraction” may refer to the percentage of fusion fuel consumed during a given reaction. The greater the burn fraction, the higher the energy output.

The term “convergence” may refer to how much a shell (or material) has been compressed radially during implosion. For instance, a shell that starts with a radius of 0.1 cm (Rᵢ) and is compressed to a radius of 0.01 cm (R_{c}) during implosion, thus having a convergence (C) of 10. That is,

$$C = \frac{{R}_{i}}{{R}_{C}}$$

The term “approximately” includes a given value plus/minus 15%. For example, the phrase “approximately 10 units” is intended to encompass a range of 8.5 units to 11.5 units.

The term “Z” refers to the atomic number of an element, i.e. the number of protons in the nucleus. The term “A” refers to the atomic mass number of an element, i.e. the number of protons and neutrons in the nucleus.

At the pressures and temperatures involved in imploding and burning ICF targets, specific material properties that one observes in everyday life (hardness, strength, room temperature thermal conductivity, etc.) may be irrelevant, and the hydrodynamic behavior of a material can depend most strongly on the material's average atomic number, atomic mass number, and solid density. As such, in discussing material requirements in ICF targets, it is convenient to discuss classes of material. For the purposes of the following discussion, the term “low-Z” will refer to materials with an atomic number of 1-5 (hydrogen to boron); the term “medium-Z” will refer to materials with an atomic number of 6-47 (carbon to silver); and the term “high-Z” will refer to materials with an atomic number greater than 48 (cadmium and above). Unless otherwise stated, the use of these terms to describe a class of material for a specific function is intended only to suggest that this class of material may be particularly advantageous for that function, and not (for instance) that a “high-Z” material could not be substituted where a “medium-Z” material is suggested, or vice-versa.

Specific material choice is still important, where indicated, as different isotopes of the same element undergo completely different nuclear reactions, and different elements may have different radiation opacities for specific frequencies. The differing solid densities of materials with similar Z is also important for certain design criteria.

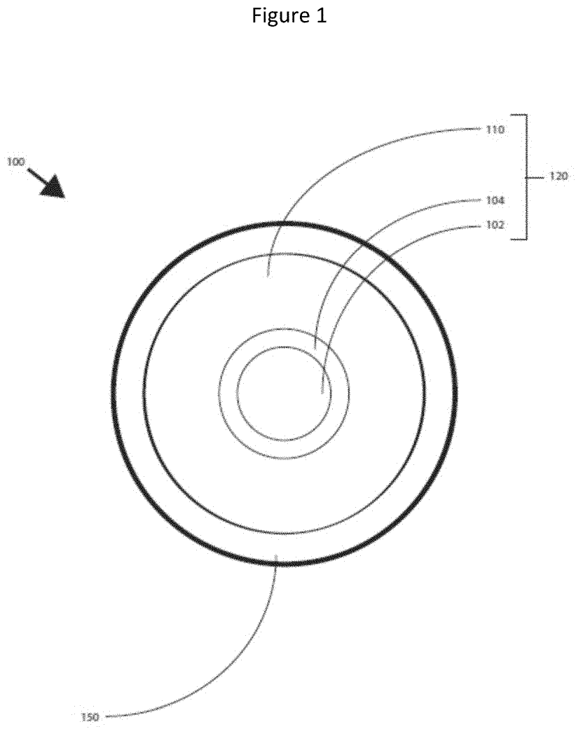

FIG. 1 shows a single shell configuration (not to scale) of an ICF target 120. ICF target 120 comprises high-Z shell 104 and fuel region 102. Fuel region 102 may be filled with equimolar deuterium and tritium (DT). DT at above approximately 0.2 g/cm³ is in a solid state, at approximately 0.16 g/cm³ in a liquid state and at approximately 0.1 g/cm³ and below at a low-density gas state. In some embodiments, fuel region 102 may have a higher ratio of deuterium to tritium, or conversely, a higher ratio of tritium to deuterium. Fuel region 102 could be filled with other types of fusion fuel such as: pure deuterium, lithium deuteride, lithium tritide, or any other fusion fuel or combination of fuels. As noted above, an ICF target 120 is placed inside a spherical hohlraum 150 and that entire structure is referred to as a target assembly 100. In some embodiments, fuel region 102 may have a higher ratio of deuterium to tritium, or conversely, a higher ratio of tritium to deuterium. Fuel region 102 may be filled with other types of fusion fuel such as: pure deuterium, lithium deuteride, lithium tritide, or any other fusion fuel or combination of fuels. Surrounding shell 104 is drive region/ablator region 110. ICF target 120 may (or may not) then be placed within a hohlraum 150. If placed in a spherical hohlraum 150, laser energy may be converted to x-ray radiation in the spherical hohlraum 150 which may then drive/ablate the drive region/ablator region 110 to implode shell 104. Or ICF target 120 may be directly driven by laser energy, or other ways known in the art, and then drive region/ablator region 110 may implode shell 104. This inward motion of shell 104 may launch a shock into fuel region 102 which may sufficiently heat fuel region 102, and simultaneously, shell 104 may compress fuel region 102 causing it to ignite and burn a significant fraction of the fuel.

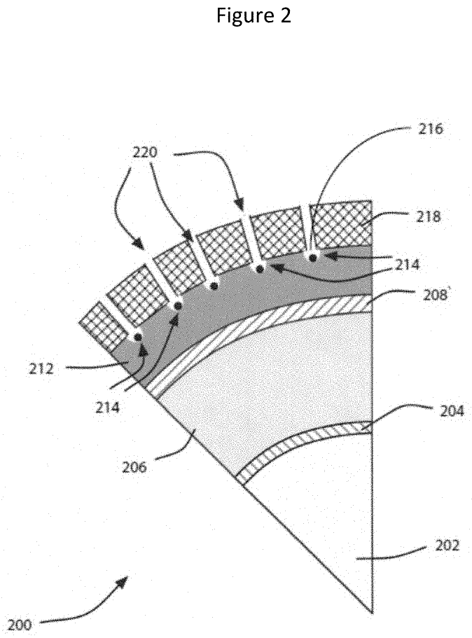

FIG. 2 depicts a double shell configuration (not to scale) of an ICF target with a propellant region. Target assembly 200 includes hohlraum 218 and ICF target. ICF target includes the following regions: inner fuel region 202, inner shell 204, outer fuel region 206, outer shell 208, and propellant region 212. Surrounding the central spherical fuel region, inner fuel region 202 is an inner shell 204 and outer shell 208. In the space between the inner shell 204 and outer shell 208 is an outer fuel region 206. Surrounding the outer shell 208 is a propellant region 212. A plurality of gold foam radiators 214 are arranged in a one-to-one correspondence with the cylindrical beam channels 220 located in hohlraum 218. The cylindrical beam channels 220 completely penetrate through hohlraum 218.

Surrounding outer shell 208 is propellant region 212. Propellant region 212 has an outer radius of 0.3083 cm. While FIG. 2 depicts propellant region 212 as having high-Z foam radiators 214 such as gold foam radiators, it would be further advantageous to fill the propellant region 212 with a low-density gas such as beryllium, any other gas having a lower density than beryllium, or to remain as a vacuum. It should also be noted that the different shapes of target assembly would require different materials in the propellant region in order to optimize the yield. Surrounding propellant region 212 is hohlraum 218, a spherical shell of solid tungsten with an outer radius of 0.3212 cm.

A multitude of cylindrical beam channels 220, each having a diameter of 100 μm, penetrate the entire thickness of hohlraum 218. The long axis of each beam channel 220 is normal to the surface of hohlraum 218. In this embodiment, there are 202 beam channels in total. Each beam channel 220 completely penetrates hohlraum 218. At the end of each beam channel 220, where they exit hohlraum 218, is a hemispherical cavity 216 in propellant region 212. These cavities 216 are approximately 100 μm in radius. Centered in the curvature of each cavity 216, and coaxial with each beam channel 220, is a gold foam radiator 214. Each gold foam radiator 214 is a sphere of gold foam 50 μm in radius, having a density of approximately 10 g/cm³.

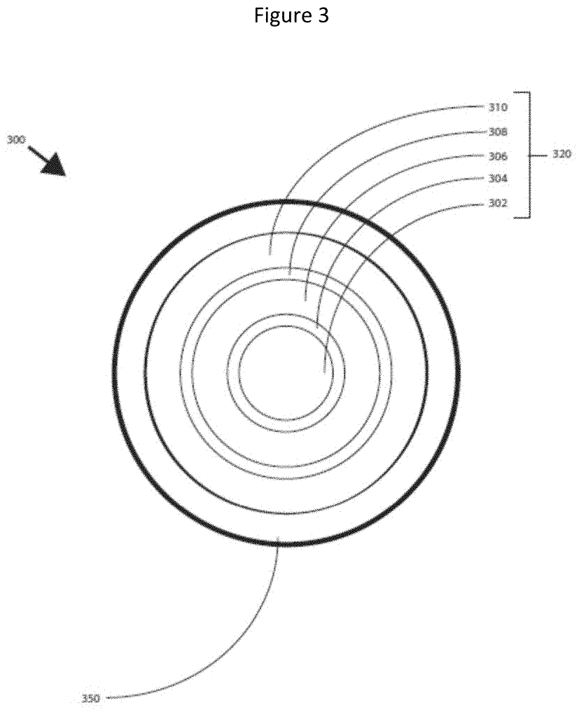

FIG. 3 depicts a double shell configuration (not to scale) of an ICF target without a propellant region (as previously described in FIG. 2). ICF target 320 includes central spherical fuel region, the inner fuel region 302. Surrounding inner fuel region 302 is inner shell 304 and outer shell 308. In the space between inner shell 304 and outer shell 308 is outer fuel region 306. Inner fuel region 302 and outer fuel region 306 may be filled with equimolar deuterium and tritium (DT). DT at above approximately 0.2 g/cm³ is in a solid state, at approximately 0.16 g/cm³ in a liquid state and at approximately 0.1 g/cm³ and below at a low-density gas state. In some embodiments, inner fuel region 302 and/or outer fuel region 306 may have a higher ratio of deuterium to tritium, or conversely, a higher ratio of tritium to deuterium. Fuel regions 302 and 306 may be filled with other types of fusion fuel, such as: pure deuterium, lithium deuteride, lithium tritide, or any other fusion fuel or combination of fuels. Some of these materials may be inert, but we will nonetheless still refer to this region as “outer fuel region” 306. Surrounding outer shell 308 is drive region/ablator region 310. As noted above, an ICF target 320 is placed inside a hohlraum 350 and that entire structure is referred to as a target assembly 300. ICF target 320 may (or may not) then be placed within a spherical hohlraum 350. If placed in a hohlraum (not shown), laser energy may be converted to x-ray radiation in the hohlraum which may then drive/ablate drive region/ablator region 310 to implode outer shell 308. Or ICF target 320 may be directly driven by laser energy, or other ways known in the art, and then drive region/ablator region 310 may implode outer shell 308. However, whether or not ICF target 320 is placed in a hohlraum 350, this inward motion of outer shell 308 may launch a shock into outer fuel region 306 which may launch a shock into inner shell 304 and subsequently inner fuel region 304. This in turn may sufficiently heat outer fuel region 306, inner fuel region 302, and simultaneously, outer shell 308 may compress outer fuel region 306. Subsequently inner shell 304 may compress inner fuel region 302 and cause it to ignite and burn a significant fraction of the fuel.

For our purposes of discussion, let us assume the following conditions. With respect to double shell configuration shown in FIG. 3, inner fuel region 302 has a radius of 0.0764 cm and is filled with deuterium-tritium gas at a density of approximately 0.1 g/cm³. Surrounding inner fuel region 302 is inner shell 304, a spherical shell of solid tungsten with an outer radius of 0.0821 cm. Surrounding inner shell 304 is outer shell 308, a spherical shell of solid tungsten with an inner radius of 0.2293 cm and an outer radius of 0.2355 cm. In the space between inner shell 304 and outer shell 308 is outer fuel region 306, filled with deuterium-tritium at a density of approximately 0.21 g/cm³. As stated above, fuels other than an equimolar mixture of DT may be used. Inert materials may be used as well, transforming fuel region 306 into a shock propagation region that does not contribute yield.

While ICF targets described above in FIGS. 1, 2 and 3 are each depicted as being placed in a spherical hohlraum, it should be noted that any other shape of hohlraum, such as but not limited to a cylindrical or rugby shaped target assembly, may be employed and that a spherical hohlraum was simply used as an example. It should also be noted that the various shapes such as a cylindrical or rugby shaped hohlraum would require different dimensions than described above. The dimensions for the inner shell, outer shell and fuel region can be adjusted to optimize the yield in the target assembly. It should also be noted that the various shapes such as a spherical, cylindrical or rugby shaped hohlraum may require different types of illumination.

Referring again to FIG. 3, target assembly 300 may be ignited in the following manner. Target assembly 300 is placed in an ICF reaction chamber, configured to contain the energy that will be released by the target. The laser light is first absorbed in the hohlraum 350 and outer shell 308. Radiation penetrates outer shell 308 and heats an outer layer of the shell material. The inner part of outer shell 308 is thus impulsively accelerated inwards, driving a strong shock into outer fuel region 306.

When the shock driven through outer fuel region 306 reaches inner shell 304, the shell will be accelerated inwardly and may reach a peak inward velocity of approximately 2.0×10⁷ cm/s. The inward motion of inner shell 304 and convergence of the shock it launches will result in compression and heating of the fuel in inner fuel region 302. The peak areal density reached in inner fuel region 302 may be 1.1 g/cm². Because of this relatively high areal density, the dominant energy loss mechanism of the fuel may be radiation emission. The high radiation opacity of inner shell 304 lowers the radiative energy loss of the fuel in inner fuel region 302 by reflecting a substantial fraction of radiated energy back into inner fuel region 302. Because of this, ignition of the fuel in inner fuel region 302 may occur at a relatively low temperature of 2.5-3 keV. Once ignited, the temperature of the fuel in inner fuel region 302 may rise further due to self-heating effects, and fusion reactions in inner fuel region 302 may produce a substantial amount of energy, e.g. approximately 36 MJ.

The high temperatures and pressures produced by fusion yield in inner fuel region 302 drive inner shell 304 outward. Outer fuel region 306 is compressed and heated by the outward motion of inner shell 304 and the remaining inward motion of outer shell 308. Outer fuel region 306 is further heated by scattering of neutrons produced by fusion reactions in inner fuel region 302 and/or by radiation emitted by fuel in inner fuel region 302. This heating and compression may lead to substantial additional fusion reactions in outer fuel region 306, which in this embodiment may produce an additional 5 MJ of yield.

In some embodiments, outer fuel region 306 may ignite and undergo runaway burn, and the majority of fusion yield from the target may be produced in outer fuel region 306. In some embodiments, heating by neutron scattering may be sufficient to heat outer fuel 306 to ignition temperature, before the PdV heating from inner shell 304 becomes significant. Increasing ρr of outer fuel region 306, e.g. by scaling the entire target proportionally to a greater size, may increase the relative fraction of yield produced by outer fuel region 306 and/or lower the threshold required for ignition of outer fuel region 306.

With respect to FIG. 2, the implosion of this embodiment is simple and robust and insensitive to many effects that conventional targets may be highly sensitive to. Further, in FIG. 2, outer shell 208 is imploded by a single shock generated by a 0.5 ns laser pulse, and the generation of this shock is not sensitive to details of the pulse shape: almost any pulse shape that delivers 9.9 MJ in a few nanoseconds or less can be used. Outer fuel region 206, inner shell 204 and inner fuel region 202 are consequently imploded primarily by this same single shock. As such, there is no need to design or optimize the power or timing of a series of multiple shocks, as are used in the NIF target as mentioned above and described in Haan, Physics of Plasmas 18, 051001 (2011), and precise knowledge of the radiation opacities of materials in the drive region is not required.

Furthermore, the embodiments in FIGS. 2 and 3 do not involve a shell “collision”. Specifically, with respect to FIG. 3, outer shell 308 never contacts inner shell 304; the acceleration of inner shell 304 is accomplished by the shock that outer shell 308 launches through outer fuel region 306. This may improve the stability properties of the implosion further, as the transfer of hydrodynamic perturbations from outer shell 308 to inner shell 304 may be significantly reduced.

The ignition process of inner fuel region 302 also has numerous advantages relative to that utilized by conventional ICF targets. Because of the large fuel mass and the high-Z material of inner shell 304 surrounding inner fuel region 302, the ignition temperature of the DT fuel in inner fuel region 302 may be approximately 2.5-3 keV, as opposed to the approximately 10 keV required for ignition of a NIF-style target. Furthermore, because of the relatively low ignition temperature and high areal density ρr, interaction with the radiation field in the DT gas may strongly damp acoustic perturbations of wavelengths comparable to the fuel dimensions, and the ignition process may be more isothermal as compared to NIF or conventional targets. Finally, ignition may occur before stagnation of the inner surface of inner shell 304 in some embodiments, which may lower the growth factors for hydrodynamic instability at the time of ignition compared to conventional targets. For these reasons, the ignition process may be much more stable against perturbations. This, along with the simplicity and robustness of the single-shock implosion process with low material convergence, can provide for high confidence in successful target operation.

These characteristics of the target implosion and ignition process may also greatly simplify the process of designing and analyzing the behavior of a given target using analytical techniques or numerical simulations.

In some embodiments, some of these advantages may become significant when the embodiment is configured to reach a peak areal density (ρr) in inner fuel region 302 of approximately 0.6 g/cm² or greater.

Numerous variations of this embodiment are possible. The density of the fuel in inner fuel region 302 may be increased or decreased, and the radius of inner fuel region 302 may be increased or decreased. Fuels other than an equimolar mixture of DT may be used, including pure deuterium fuel, or fuels with a reduced tritium concentration. A decrease in the density of the fuel in inner fuel region 302 may increase the temperatures achieved during implosion of inner fuel region 302, but may also decrease the peak ρr achieved and increase the temperature required for ignition. An increase in radius of inner fuel region 302 while maintaining a fixed density may improve ρr, while decreasing peak temperature achieved during implosion or requiring more drive energy to achieve the same temperature.

Generally speaking, increasing the thickness of outer fuel region 306 may increase the strength of the shock that accelerates inner shell 304, and improve ignition characteristics of inner fuel region 302. This may increase the amount of energy required to drive the target and/or increase the sensitivity of the target to drive non-uniformity.

Other materials may be substituted for the DT fuel in outer fuel region 306. Some of these materials may be inert, but we will nonetheless still refer to this region as the “outer fuel region” 306. Increasing the density of the material used in outer fuel region 306 may decrease the fluid velocity behind the shock and affect the acceleration profile of inner shell 304. Use of low-Z materials in outer fuel region 306 may be advantageous, to minimize the energy spent on ionization.

The thickness of inner shell 304 and outer shell 308 may be increased or decreased. Use of high-Z materials, or materials with a high opacity to radiation in the 0.5-3 keV range, may be advantageous in inner shell 304, but other materials may be substituted as well. The thickness of inner shell 304 may affect the implosion of inner fuel region 302. Reducing the thickness of inner shell 304 may lead to higher implosion velocities in some embodiments, but a thinner inner shell 304 may be more susceptible to disruption from hydrodynamic instabilities.

The laser pulse length and total energy may be varied as well. As the target is scaled up or down proportionally, the laser energy may be scaled with the cube of the relative change in radius, and this may preserve the overall hydrodynamic behavior of the target. If the laser energy is increased while the other target dimensions remain constant, the strength of the shock launched into outer fuel region 306 may be increased, the maximum velocity of inner shell 304 may be increased, and the peak compression and/or heating of inner fuel region 302 may be increased.

The minimum size at which embodiments of this invention will function successfully may be determined in part by the ρr achieved in inner fuel region 302. As any given embodiment is reduced in size while maintaining hydrodynamic equivalence, the ρr achieved in inner fuel region 302 during implosion will decrease. As ρr decreases, the mechanism of operation of the embodiment will gradually change, and below a certain threshold, some or all of the advantages described above may be lost and ignition may not occur. For example, as ρr decreases, the temperature required to achieve ignition in inner fuel region 302 will increase. Radiation damping of perturbations in inner fuel 302 will decrease and electron thermal conduction, as opposed to radiation transport, will become the dominant mechanism of energy loss from inner fuel 302. Thus, the target will move away from the equilibrium ignition regime, and ignition of inner fuel 302 will become more dependent on the details of hydrodynamic motion and temperature profiles achieved in inner fuel 302, and thus may become more sensitive to perturbations introduced into inner fuel 302 by non-uniformity in the target's manufacturing or drive mechanism. At some point as the size of the embodiment is reduced, the implosion velocity and/or uniformity of implosion will be insufficient to achieve ignition of inner fuel 302, given the reduced ρr. The exact point at which this transition occurs may vary between embodiments but in general, the minimum ρr for successful operation may be characterized as an areal density of approximately 0.6 g/cm in the entire inner fuel region 302, evaluated at the time of stagnation of the inner surface of inner shell 304. The minimum size for embodiments of this invention may be bounded by the size necessary to achieve this ρr while still being imploded by an impulsive drive mechanism and a single strong shock.

Embodiments of this invention discussed in this application were designed using numerical simulations and hand calculations. This design process necessarily involves making approximations and assumptions. The description of the operation and characteristics of the embodiments presented above is intended to be prophetic, and to aid the reader in understanding the various considerations involving in designing embodiments, and is not to be interpreted as an exact description of how the embodiments will perform, an exact description of how various modifications will change the characteristics of an embodiment, nor as the results of actual real-world experiments.

Additionally, the set of embodiments discussed in this application is intended to be exemplary only, and not an exhaustive list of all possible variants of the invention. Certain features discussed as part of separate embodiments may be combined into a single embodiment. Additionally, embodiments may make use of various features known in the art but not specified explicitly in this application.

Embodiments can be scaled-up and scaled-down in size, and relative proportions of components within embodiments can be changed as well. The range of values of any parameter (e.g. size, thickness, density, mass, etc.) of any component of an embodiment of this invention, or of entire embodiments, spanned by the exemplary embodiments in this application should not be construed as a limit on the maximum or minimum value of that parameter for other embodiments, unless specifically described as such.

1. A target assembly for imploding and igniting an Inertial Confinement Fusion (ICF) target within a hohlraum, the target assembly comprising:
an ICF target comprising:
an inner fuel region; and
an inner shell, wherein the inner shell is disposed directly surrounding and in direct contact with the inner fuel region;
a hohlraum to centrally receive the ICF target;
wherein the inner fuel region of the ICF target reaches an areal density above approximately 0.6 g/cm² during implosion and ignition.

2. The target assembly of claim 1, wherein the inner fuel region is comprised of deuterium-tritium gas having a density of approximately 0.1 g/cm³.

3. The target assembly of claim 2, wherein the inner shell region is comprised of solid tungsten.

4. The target assembly of claim 3, wherein the hohlraum is spherical, cylindrical or rugby-shaped.

5. The target assembly of claim 4, wherein the inner shell region reflects a fraction of radiated energy back into the inner fuel region.

6. The target assembly of claim 5, wherein the inner fuel region reaches an areal density above approximately 1.1 g/cm² during implosion and ignition.

7. The target assembly of claim 5, wherein the ICF target further comprises:
an outer fuel region, wherein the outer fuel region is disposed directly surrounding and in direct contact with the inner shell; and
